(19) United States
(12) Patent Application Publication
(10) Pub. No.: US 2015/0336495 A1
(43) Pub. Date: Nov. 26, 2015

(54) METHOD AND APPARATUS FOR PERSONAL ENTERTAINMENT DEVICE MOUNTING

(71) Applicant: Reliant Worldwide Plastics, LLC, Plano, TX (US)

(72) Inventor: William H. Maslakow, Plano, TX (US)

(73) Assignee: Reliant Worldwide Plastics, LLC, Plano, TX (US)

(21) Appl. No.: 14/719,668

(22) Filed: May 22, 2015

Related U.S. Application Data
(60) Provisional application No. 62/096,278, filed on Dec. 23, 2014.
(60) Provisional application No. 62/002,594, filed on May 23, 2014.

(51) Int. Cl. B60N 3/00; F16B 2/12; F16M 13/02; F16B 2/18

(52) U.S. Cl. CPC B60N 3/00; F16B 2/185; F16B 2/12; F16M 13/022

(57) ABSTRACT

A mount assembly for a personal entertainment device that, in various embodiments, may include a mount plate and a rotatable bracket element coupled to the mount plate. An enclosure is coupled to the rotatable bracket element. The enclosure includes a plurality of adjustable retention members slidably disposed in the enclosure. At least one retention member of the plurality of adjustable retention members is linearly adjustable to facilitate receipt of a personal device by the enclosure.

### CROSS-REFERENCE TO RELATED APPLICATIONS

This application claims the priority to, and incorporates by reference for any purpose, the entire disclosure of, U.S. Provisional Patent Application No. 62/002,594, filed May 23, 2014. This application claims priority to, and incorporates by reference for any purpose, the entire disclosure of U.S. Provisional Patent Application No. 62/096,278, filed Dec. 23, 2014.

### BACKGROUND

1. Field of the Invention

The present application relates generally to seats for commercial aircraft and more particular, but not by way of limitation, to a thermoplastic mounting device for securing a personal entertainment device to a seat back.

2. History of the Related Art

Many current airlines provide a seatback mounted screen for each seat that, for example, allow passengers in each seat to view the screen for entertainment purposes. Such permanently mounted screens may soon become obsolete given the proliferation of handheld personal devices. It may, therefore, be advantageous in the near future to remove the permanently mounted screens in aircraft while still allowing the option to have a mounted screen rather than having to hold their device during use.

Additionally, in the commercial aircraft industry, weight and safety are important issues. Even non-structural and non-critical elements like a seat back on a commercial aircraft are designed with these issues in mind. For example, a weight savings on each seat back can add up to significant weight savings for the aircraft as a whole due, in no small part to the large number of seats. The weight saving in turn may reduce then fuel expenditure and provide a cost savings. In the specific case of seat backs, any such weight reduction must not adversely affect strength. Typically, governmental rules and regulations specify strength requirements for aircraft elements, and at the very least, strength issues may impact durability and expected lifespan of an element, such as a seat back. Cost is also a driving factor in the commercial aircraft industry, so low-cost manufacturing techniques may be important as well. Disclosed embodiments relate to improved entertainment device mount embodiments that may address one or more of these issues.

### SUMMARY

The present application relates generally to seats for commercial aircraft and more particular, but not by way of limitation, to a thermoplastic mounting device for securing a personal entertainment device to a seat back. In one aspect, the present invention relates to a mount assembly for a personal entertainment device that, in various embodiments, may include a mount plate and a rotatable bracket element coupled to the mount plate. An enclosure is coupled to the rotatable bracket element. The enclosure includes a plurality of adjustable retention members slidably disposed in the enclosure. At least one retention member of the plurality of adjustable retention members is linearly adjustable to facilitate receipt of a personal device by the enclosure.

In another aspect, the present invention relates to a method of mounting a personal entertainment device. In various embodiments, the method may include adjusting a retention member to facilitate receipt of the personal entertainment device into an enclosure and placing the personal entertainment device in the enclosure. In various embodiments, the method may further include adjusting the retention member such that the personal entertainment device is secured in the enclosure and adjusting, via a rotatable mounting bracket, a position of the enclosure to facilitate viewing.

### BRIEF DESCRIPTION OF THE DRAWINGS

For a more complete understanding of the present invention and for further objects and advantages thereof, reference may now be had to the following description taken in conjunction with the accompanying drawings in which:

FIG. 1 is an exploded perspective view of a mounting assembly according to an exemplary embodiment;

FIG. 2A is a side view of the mounting assembly in a collapsed state according to an exemplary embodiment;

FIG. 2B is a side view of the mounting assembly in an extended state according to an exemplary embodiment;

FIG. 3A is a rear view of a mounting enclosure according to an exemplary embodiment;

FIG. 3B is a side view of the mounting enclosure according to an exemplary embodiment;

FIG. 4 is a cutaway view of the mounting enclosure illustrating internal components thereof according to an exemplary embodiment;

FIG. 5A is a side view of a mounting button according to an exemplary embodiment;

FIG. 5B is an exploded perspective view of an interface between the mounting button and an aperture according to an exemplary embodiment;

FIG. 5C is a cross-sectional view of the interface between the mounting button and an aperture according to an exemplary embodiment; and

FIG. 6 is a cutaway view of the mounting enclosure having a plurality of levers illustrating internal components thereof according to an exemplary embodiment;

### DETAILED DESCRIPTION

Various embodiments of the present invention will now be described more fully with reference to the accompanying drawings. The invention may, however, be embodied in many different forms and should not be construed as limited to the embodiments set forth herein.

The following brief definition of terms shall apply throughout the application:

The term “comprising” means including but not limited to, and should be interpreted in the manner it is typically used in the patent context;

The phrases “in one embodiment,” “according to one embodiment,” and the like generally mean that the particular feature, structure, or characteristic following the phrase may be included in at least one embodiment of the present invention, and may be included in more than one embodiment of the present invention (importantly, such phrases do not necessarily refer to the same embodiment);

If the specification describes something as “exemplary” or an “example,” it should be understood that refers to a non-exclusive example;

The terms “about” or approximately” or the like, when used with a number, may mean that specific number, or alternatively, a range in proximity to the specific number, as understood by persons of skill in the art field; and

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

Some disclosed embodiments may generally relate to an extension of concepts of embodiments previously disclosed in related provisional U.S. patent application 61/711,567 and related U.S. non-provisional patent application Ser. No. 14/048,840, entitled Thermoplastic Injection Molded Element with Integral Thermoplastic Positioning System for Reinforced Composite Structures, filed respectively Oct. 9, 2012 and Oct. 8, 2013, and related U.S. provisional patent application 61/988,080 entitled “Seat Back” and filed May 2, 2014, which are co-owned and hereby incorporated by reference to the extent it does not contradict the express disclosure herein. More specifically, disclosed embodiments may relate to personal entertainment device mount assembly embodiments, which may in some instances be formed using composite materials and/or thermoplastic molded materials such that disclosed embodiments might be a specific application and/or modification of the previous provisional patent technology.

Disclosed embodiments may relate to a seat back mounted thermoplastic personal entertainment device mount, utilized in the commercial aerospace industry, comprised of an injection molded assembly with integral device dimension adjustment to allow the retention of numerous dimensioned personal entertainment devices.

In various embodiments, such device mount assembly embodiments may further be comprised of thermally formed thermoplastic encapsulated unidirectional or weave carbon or glass reinforced composite structures with integral homogeneous injection molded thermoplastic support elements that provide a portion of the structural requirements and reduce device mount assembly weight. Such device mount assembly embodiments may further be comprised of integral thermoplastic injection molded elastomeric elements that provide damage-free personal device retention. Typically, such device mount assembly embodiments may further be comprised of integral thermoplastic injection molded elements that provide user selected device dimension adjustment feature.

In various embodiments, the device dimension adjustment feature may further be comprised of an integral rotatable locking user adjustment to maintain the user selected device dimension during initial device installation. Such device dimension adjustment integral rotatable locking feature may additionally permit the removal of the personal entertainment device upon the completion of use.

In various embodiments, the device mount may further be comprised of injection molded attachable rotatable elements that provide a user selectable field and distance of view during reclining of the forward facing seat assembly. Such attachable rotatable elements may further be comprised of integral restrictive rotational pivot bearings that permit retention of the user selected position during use and during the environment of air travel.

In various embodiments, the attachable rotatable elements may further be comprised of at least one element with integral device mount-to-seat back mounting buttons for the installation and retention of the device mount to a commercial seat back assembly. Said mounting buttons of device may be operable to mount interface with suitable located mounting button apertures located on a forward positioned commercial airline seat back.

In some embodiments, the mounting button apertures may further be comprised of pivoting spring-loaded aperture covers, which displace rotationally during installation of the device mount mounting button, and return to an initial position upon removal of said device mount. Such aperture covers, in various embodiments, may further be comprised of integral thermoplastic injection molded spring deflecting elements that provide resistive pressure to permit the aperture cover to return to the initial position upon removal of the device mount.

Typically, disclosed embodiments may further be comprised of materials that comply with FAR 25.853 and OSU 55/55 when applicable. For example, personal entertainment device mount assembly embodiments (which comply to FAR 25.853 and OSU 55/55), may be comprised of integral injection molded thermoplastic elements and thermoplastic reinforced composite structures, providing damage free locking user selectable dimension device retention and user selectable field of and distance of view, and a plurality of integral mounting buttons which mate and install into a commercial airline seat back assembly with rotatable integral spring actuated closable mounting button aperture covers to eliminate user pinch injury.

Disclosed embodiments may, in various embodiments, be comprised of chemical and molecular compatible thermoplastics resins throughout the assembly, creating an infinite number of homogenous connective attachments that provide additional consistent strength, dimensional stability, and rigidity.

Disclosed embodiments may, in various embodiments, provide increased mechanical load bearing capabilities provided by the integral formed thermoplastic carbon or glass reinforced composite element with the integral injection molded carbon or glass fiber reinforced thermoplastic support structure by the infinite number of homogeneous connective interfaces.

In some embodiments, the integral formed thermoplastic encapsulated carbon or glass reinforced composite element may comprise multiple weave patterns, multiple layers and multiple layer orientations to provide optimum performance for the requirement load application.

Disclosed embodiments may reduce the current weight of a comparable personal entertainment device mount assembly through the use of high strength to weight ratio thermoplastic materials and composites. Disclosed embodiments may, in various embodiments, eliminate the scrap rejections inherent to the current thermoset epoxy assemblies, including delamination and reinforcement disassociation.

In various embodiments, disclosed embodiments generally relate to personal entertainment device mount assemblies to be used with seat backs for aircraft. In some embodiments, the personal entertainment device mount assembly may be removably attached to a seat back. Typically, disclosed elements of a device mount assembly may be formed of one or more layers of composite material. For example, the elements of the device mount assembly might comprise a composite structure having one or more layers of composite material. Each layer of composite material typically has reinforcing fibers such as, for example, a weave of reinforcing fibers located internally, with thermoplastic surrounding the reinforcing fibers atop and below the fibers. For example, the composite material typically would only have reinforcing fibers located internally, for example in a central plane. When multiple layers of composite material form the elements of assembly, the multiple layers of composite typically would be thermally or homogeneously joined together to form a unitary structure with a homogeneous connective interface throughout. Typically, the one or more layers of composite material may be shaped into the form of elements of the device mount assembly and configured to attach to a rear of an airline seat back assembly.

In some embodiments, one or more of the elements of the device mount assembly are injection molded onto the composite material. Since the elements typically are formed of the same thermoplastic as the composite material, the elements typically are thermally or homogeneously attached to the composite material. Specific embodiments related to the figures will be discussed in more detail below.

For example, the composite material typically comprises an array of reinforcing fibers such as, for example, carbon, graphite, glass, or aramid fibers. In a typical embodiment the fibers include carbon microscopic crystals aligned parallel to the longitudinal axis of the carbon fibers. In a typical embodiment, the fibers are aligned in a precise orientation and include a thermoplastic material such as, for example, a sheathing located about the array of reinforcing fibers. In various embodiments, the array of fibers is a weave pattern, for example, a five harness satin weave, in some embodiments, while in other embodiments the array of fibers may be aligned uni-directionally in a parallel linear pattern. In some embodiments, the composite is provided in pre-defined or pre-formed solid three dimensional geometries, such as a solid sheet, which sheet can then be shaped according to the needs of the specific element such as, for example, by heat forming or cutting. Since such a composite material typically may be a rigid solid at room temperature and only softens sufficiently to allow shaping such as bending or twisting at elevated temperatures, there would typically be no need for an external frame to hold the composite in the desired shape or position while forming encapsulating thermoplastic about the composite using injection molding in order to form any desired additional element. In other words, once the composite sheet material is shaped as desired for the particular device mount assembly and has cooled to room temperature, it is a rigid solid that will independently hold the shape in question, and should not need any framework to hold its shape within the mold for forming thermoplastic elements onto the composite.

In other embodiments, the composite material is formed by layering thermoplastic film and reinforcing fiber cloth or weave, which layers would then be consolidated, for example via heat and/or compression, into a unitary composite material with reinforcing fibers located between two thermoplastic layers. For example, each composite material layer might comprise two thermoplastic film layers sandwiching or surrounding a layer of reinforcing fiber such as, for example a weave of reinforcing fiber. The one or more layers of composite might then be placed on a press mold for the shape of a personal entertainment device mount assembly element, with the press mold then being used to consolidate the one or more layers of composite such as, for example, the one or more layer of reinforcing fibers with the two or more layers of thermoplastic, thereby forming the composite device mount assembly element structure.

Typically, the array of fibers of the composite material would be located (only) near the center (thickness) of the composite material in a central plane, with thermoplastic material located atop and beneath the array of fibers. In other words, the composite material would typically have all of the reinforcing fibers located in a single/central plane, with the rest of the thickness of the composite material being formed of thermoplastic material. Regardless, the composite typically might provide approximately consistent fiber distribution and orientation throughout the element, so that the composite can provide precise, consistent, and reproducible structural or mechanical support. While many embodiments may be formed of such composite material, with or without encapsulating thermoplastic, it should be understood that the specific material used to form on or more elements of exemplary mount embodiments is optional such that other material might also be used in various embodiments.

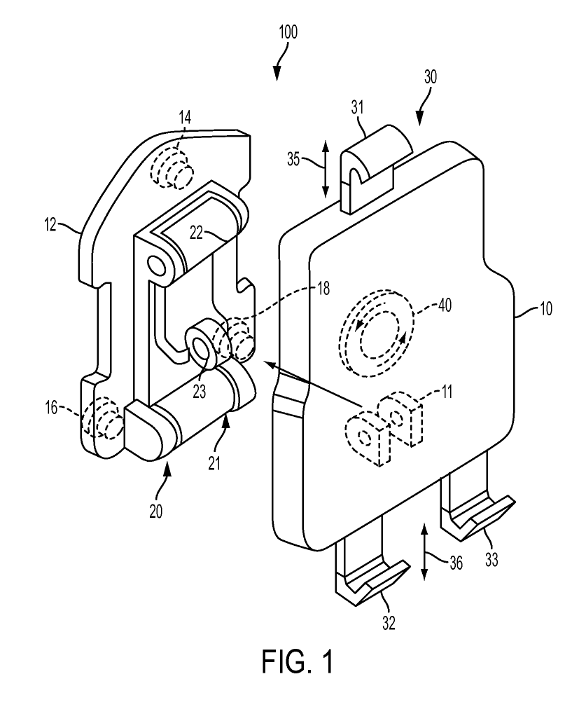

FIG. 1 illustrates an exploded perspective view of an exemplary personal entertainment device mount assembly 100, with a molded enclosure 10 coupled or mounted to a mount plate 12. In a typical embodiment, the mount plate 12 attaches to a seat back via one or more mount buttons 14, 16, and 18. The mount plate 12 comprises rotatable bracket elements 20. The rotatable bracket elements 20 include a first rotatable bracket 21 and a second rotatable bracket 22. In a typical embodiment, the molded enclosure 10 mounts to the mount plate 12 via a bracket 11 that fits with the second rotatable bracket 22 via a mount 23. For example, a bolt passes through the bracket 11 and the mount 23 to form a pivot attachment. In a typical embodiment, the mount 23 rotates within the bracket 11. The molded enclosure 10 includes a device retention system 30 that comprises one or more elastomeric retention elements 31, 32, and 33 operable to hold a personal entertainment device in place against the front face of the molded enclosure 10. Typically, the retention elements include at least two retention elements, with at least one retention element located on opposing sides off the device retention system 30. In a typical embodiment, the retention elements 31, 32, and 33 are operable to move outward from the molded enclosure, for example by moving in a vertical direction as illustrated by arrows 35 and 36, in the embodiment of FIG. 1. Such vertical movement of the retention elements 31, 32, and 33 is controlled by a dimension adjustment feature 40. In a typical embodiment, the dimension adjustment feature 40 is located on the rear face of the molded enclosure 10. In some embodiments, one or more of the elements of the device mount assembly 100 described above may comprise thermoplastic material or composite material.

Thus, the molded enclosure 10 with retention elements 31, 32, and 33 and dimension adjustment feature 40 operates to removably fix a personal device 200. Further, the mount plate 12 with the rotatable bracket elements 20 allows for repositioning of such a mounted device 30. In other words, the pivoting attachment of the molded enclosure 10 to the mount plate 12 may allow for a mounted device to be repositioned by a user such as, for example, if the seat back in front of the user is reclined. Typically, the molded enclosure 10 is coupled to the mount plate 12 in such a way as to provide at least three pivot points for position adjustment.

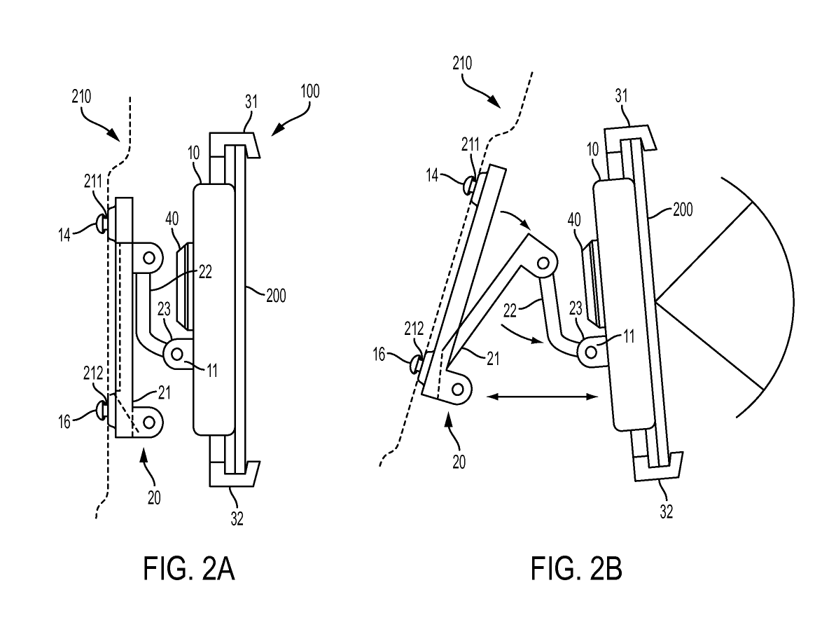

FIG. 2A illustrates an exemplary side view of the device mount assembly 100 of FIG. 1 when the seat back 210 is in an upright position. In a typical embodiment, the device mount assembly 100 holds a personal entertainment device 200 via the retention elements 31, 32 and 33 (not shown). In the embodiment shown in FIG. 2A, the device mount assembly 100 may be in a “closed” position, wherein the rotatable bracket elements 20 may be in a first “closed” position.

FIG. 2B illustrates an exemplary side view of the device mount assembly 100 when the seat back 210 is in a reclined position. In a typical embodiment, the rotatable bracket elements 20 are in a second “expanded” position, wherein the first bracket 21 and the second bracket 22 are operable to rotate/pivot independently to provide a wide range of movement of the molded enclosure 10 to position the personal entertainment device 200 at a desired angle for the user to view. In some embodiments, the rotatable bracket elements comprises integral restrictive rotational pivot bearings that permit retention of the user selected position, such as, for example, the closed and expanded positions shown in FIGS. 2A-2B, during use.

As shown in FIGS. 2A-2B, the device mount assembly 100 is attached to the seat back 210 via the one or more mount buttons 14, 16, and 18 (not shown). In some embodiments, the seat back 210 comprises apertures 211 and 212 operable to interface with the one or more mount buttons 14 and 16. It should be understood, however, that this exemplary mount button embodiment for attaching the mount plate 12 to the seat back 210 is merely one exemplary means to attach the mount plate 12 to the seat back 210; and other attachment means are also included within the scope of this disclosure.

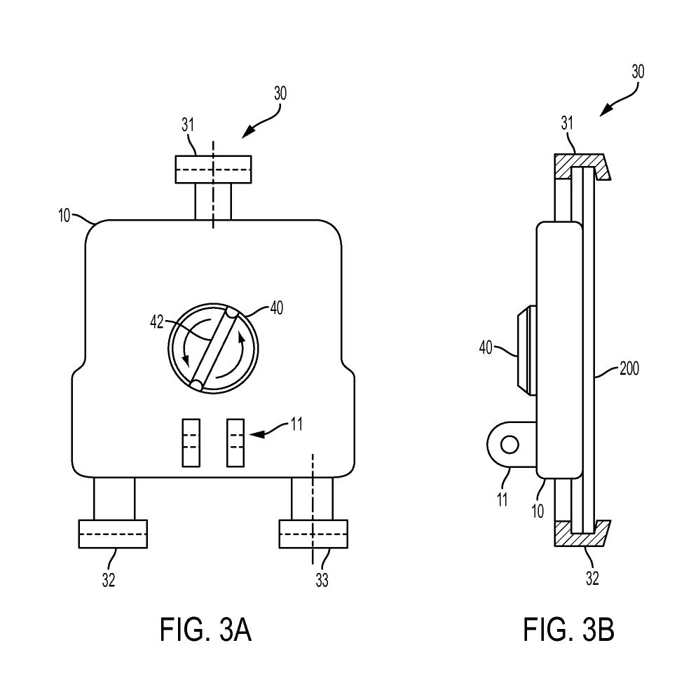

FIGS. 3A-3B illustrate a detailed view of the molded enclosure 10 with the device retention system 30. In some embodiments a dimension adjustment feature 40 is located above the mount 11 on a rear of the molded enclosure 10, which location allows a user access to the adjustment feature 40 to control adjustment of the retention elements 31, 32, 33. In a typical embodiment, the dimension adjustment feature 40 is operable to move rotationally, and comprises a handle 42, which handle 42 is grasped by a user to rotate the dimension adjustment feature 40. In an exemplary embodiment, a user may place a personal device 200, such as a tablet, within the retention elements 31, 32, and 33. In a typical embodiment, the user rotates the dimension adjustment feature 40 to move the retention elements 31, 32, and 33 inward such as, for example in a vertical direction, such that the retention elements 31, 32, and 33 fit snuggly around the edges of the personal device 200, as shown in FIG. 3B. In a typical embodiment, the retention elements 31, 32, and 33 are formed of a material that prevents damage to the personal device 200 when the personal device 200 is held by the retention elements 31, 32, and 33. For example, in some embodiments, the retention elements 31, 32, and 33 comprise thermoplastic polyurethane (TPU) material or composite material.

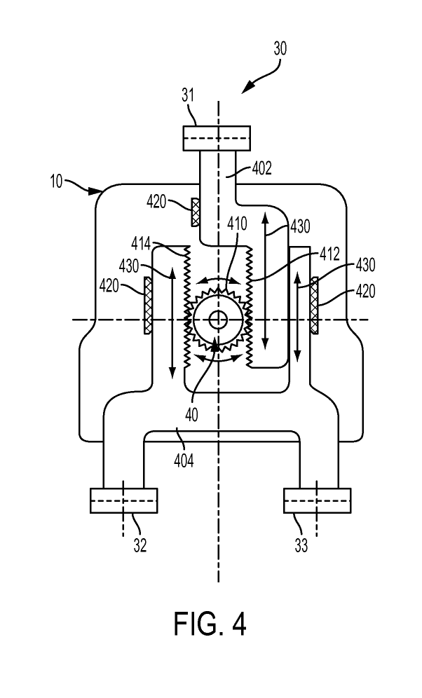

FIG. 4 illustrates a cut-away view of the molded enclosure 10 to show the inner workings of the retention system 30 within the molded enclosure 10. The retention elements 31, 32, and 33 are mounted to support pieces 402 and 404. In a typical embodiment, the retention system 30 comprises a top support piece 402 and a bottom support piece 404. The top and bottom support pieces 402 and 404 are operable to move vertically within the molded enclosure 10, as shown by arrows 430. In some embodiments, the top and bottom support pieces 402 and 404 move in opposite directions. That is, when the top support piece 402 is adjusted upward or away from the molded enclosure 10, the bottom support piece 404 is moved downward and also away from the molded enclosure 10. In other words, the top and bottom support pieces 402 and 404 may both move away from the molded enclosure 10 or toward the molded enclosure 10. In other embodiments, however, one or more of the retention elements 31, 32, 33 and a corresponding one of the top and bottom support pieces 402 and 404 might be fixed, such that the adjustment only affects some of the retention elements, and their movements with respect to the fixed retention element(s) might allow for securement of the device. In some embodiments, one or more of the top and bottom support pieces 402 and 404 comprise teeth 412 and 414, respectively, on at least a portion of their surface, which teeth 412 and 414 are operable to interact with teeth 410 located on an outer edge of the adjustment feature 40 such that the adjustment feature comprises a gear with teeth and the teeth of the support pieces interacts/intermeshes with the gear teeth 410. For example, in various embodiments, a rack and pinion gear set might be formed to provide adjustment. Rotation of the adjustment feature 40 may cause the support pieces 402 and 404 to move vertically via the interaction of the teeth 410 of the adjustment feature with the teeth 412 and 414 of the top support piece 402 and the bottom support piece 404. The top support piece 402 and the bottom support piece 404 are held in place with respect to one direction such as, for example, in a horizontal direction by guide bearings 420, such that the only movement of the top and bottom support pieces 402 and 404 is in a single direction such as, for example, the vertical direction of FIG. 4. In some embodiments, the adjustment feature 40 comprises a locking element operable to hold the top and bottom support pieces 402 and 404 in a specific vertical position until the adjustment feature 40 is unlocked. In various embodiments, the locking element prevents the top and bottom support pieces 402 and 404 from moving. Therefore, the locking element also prevents the retention elements 31, 32 and 33, from moving while a personal device is held by the retention elements 31, 32, and 33. In other embodiments, the adjustment feature 40 employs a resistance mechanism to securely hold a position such as, for example, when the device is seated and held by the retention elements. In some embodiments, the elements of the device retention system 30 may comprise thermoplastic material or composite material.

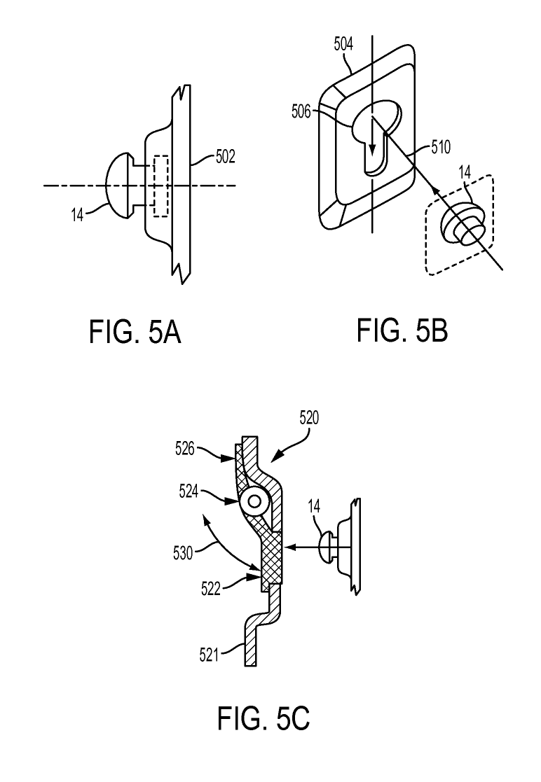

FIG. 5A illustrates a detailed view of an exemplary embodiment of a mount button 14 such as, for example, the type of mount button shown in FIG. 2 for mounting the mount plate to the seat back. The mount button 14 is attached to a molded mount bracket 502, which bracket 502 connects the mount button 14 to the mount plate 12. FIG. 5B illustrates how a mount button 5B may attach to the seat back 210 (of FIGS. 2A-2B). A mount button receptacle 504 is integrated into, or attached onto, the seat back 210. The mount button receptacle 504 comprises an aperture 506 which aperture may be similar to the apertures 211 and 212 of FIGS. 2A-2B. The aperture 506 is shaped such that a head portion of the button 14 fits through a portion of the aperture 506 and then slides down and be held in place by a narrower portion of the aperture 506, as illustrated by arrows 510. For example, the aperture 506 might have a key hole shape which is larger toward the top and narrower toward the bottom. The larger portion of the aperture 506 provides clearance for insertion of the head portion, while the narrower (lower) portion of the aperture 506 is too narrow for the head portion to pull out but wide enough for the neck of the button to extend outward. Such a button/aperture design allows for removable attachment of the mount device 30 to the seat back 210, with the removable attachment being quick and easy to secure, but also providing secure attachment to fix the mount onto device 30 to the seat back 210. In a typical embodiment, the elements of the button receptacle 504 comprises thermoplastic material or composite material.

FIG. 5C illustrates a button receptacle 520 that is formed into a seat back 521 and includes a pivoting door to guard against finger pinch. The button receptacle 520 comprises a door 522 and pivot 524 mechanism, wherein the button 14 pushes the door 522 in the direction indicated by arrow 530 about the pivot 524 when the button 14 is inserted into the button receptacle 520. In some embodiments, the door 522 comprises a spring 526 operable to bias the door 522 towards a closed position, such that when the button 14 is removed from the receptacle, the door 522 pivots back to the position shown in FIG. 5C. In a typical embodiment, the elements of the button receptacle 520 may comprise thermoplastic material and/or composite material.

Though not specifically illustrated, in various embodiments, the mount device 30 may be secured to the seat back 210 via, for example, rare Earth magnets. In such an embodiment, the mount plate 12 includes, for example, three rare Earth magnets. The rare Earth magnets may be attached to the mount plate 12 via, for example, a pressure sensitive adhesive. The mount plate 12 would be removably attached to the seat back 210 through an attraction force between the rare Earth magnets and, for example, a ferromagnetic material in the seat back 210. In various embodiments, the mount device may be secured to the seat back via, for example, suction cups. In such an embodiment, the mount plate 12 includes, for example, three suction cups. The suction cups may be removably attached to the seat back 210 on a smooth area of the seat back 210.

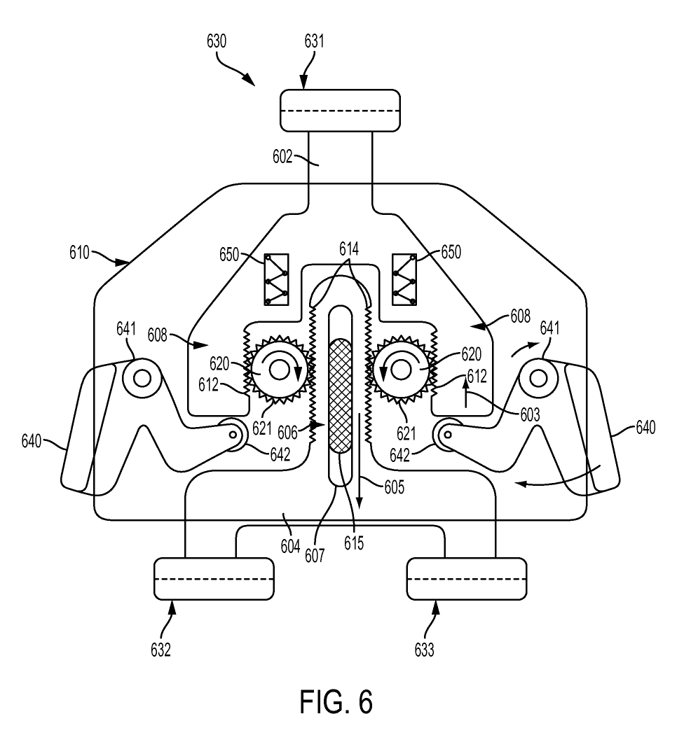

FIG. 6 illustrates a cut-away view of a molded enclosure 610 of an alternative embodiment of a retention system 630, to better show the inner workings of the retention system 630 within the molded enclosure 610. The retention system 630 comprises retention elements 631, 632, and 633, which may be similar to retention elements 31, 32 and 33 described above. The retention elements 631, 632 and 633 are mounted to support pieces 602 and 604. In some embodiments, the retention system 630 comprises a top support piece 602 and a bottom support piece 604. In a typical embodiment, the support pieces 602 and 604 are operable to move vertically within the molded enclosure 610, as shown by arrows 603 and 605. In some embodiments, the support pieces 602 and 604 move in opposite directions, i.e. when the top support piece 602 is adjusted upward or away from the molded enclosure 610, the bottom support piece 604 is moved downward and also away from the molded enclosure 610. In other words, the support pieces 602 and 604 may both move away from the molded enclosure 610 or toward the molded enclosure 610. In other embodiments, however, one or more of the retention elements and its support piece might be fixed, such that the adjustment only affects some of the retention elements, and their movements with respect to the fixed retention element(s) might allow for securement of the device.

Still referring to FIG. 6, the movement of the support pieces 602 and 604 is controlled by one or more levers 640 operable to interact with one or both of the support pieces 602 and 604. The levers 640 comprise bell crank style levers that, when pushed, rotate about a pivot 641, wherein the pivot 641 may be fixed within the molded enclosure 610. The motion of the lever 640 about the pivot 641 is utilized in many ways, one of which is to push or pull a component that is in contact with the lever. In the embodiment shown in FIG. 6, the movement of the lever(s) 640 may push the top support piece 602 upwards, or outward from the molded enclosure 610, as indicated by arrow 603.

In some embodiments, the top support piece 602 is biased by one or more springs 650 in a downward direction, such that if the levers 640 are released, the top support piece 602 moves downward, or toward the molded enclosure 610. Such a configuration ensures that any device mounted within the retention elements 631, 632, and 633 is securely held until the lever(s) 640 are pressed to move the retention elements outward to release the device. In other embodiments, the direction of motion of the levers 640 or springs 650 may be different, wherein the springs 650 may bias one or both of the support pieces against the movement of the lever(s) 640. In other words, when the lever(s) 640 are pushed, the lever(s) 640 may move the support piece(s) to compress the spring(s) 650, and when the lever(s) 640 are released, the spring(s) 650 may bias the support piece(s) back to a resting position. In some embodiments, the levers 640 comprise rollers 642 that contact the top support piece 602. In other embodiments, the rollers 642 are part of at least one of the support top support piece 602 and the bottom support piece 604.

In the embodiment of FIG. 6, the top support piece 602 comprises teeth 612 that interface with one or more round gear 620, wherein the teeth 621 of the round gear(s) 620 interface with the linear teeth 612 of the top support piece 602. In some embodiments, the gear(s) 620 and/or lever(s) 640 may be considered to be part of a dimension adjustment feature (similar to dimension adjustment feature 40 described above). Additionally, the bottom support piece 604 comprises teeth 614, wherein the teeth 621 of the round gear 620 interfaces with the linear teeth 614 of the bottom support piece 604. In other words, the gear 620 are typically located between the top support piece 602 and the bottom support piece 604 such that the gear 620 contacts the portion of the top support piece 602 and bottom support piece 604 having teeth).

The round gear 620 rotate and provide a reverse motion of the top support piece 602 to the bottom support piece 604. In other words, whenever the top support piece 602 is moving outwardly 603 such as, for example, when the top support piece 602 is moved by the lever 640, the bottom support piece 604 is also moving outwardly but in an opposite direction 605. For example, pressing the lever(s) 640 moves the top support piece 602 upward, while moving the bottom support piece 604 downward due to interaction with the gear 620. In some embodiments, the movement of the bottom support piece 604 is guided by a guide bearing 615 (which might ensure linear motion along a specific path).

In the embodiment of FIG. 6, there are two round gears 620. The bottom support piece 604 includes a vertical element 606 that extends along a line from a bottom of the molded enclosure 610 toward a top of the molded enclosure 610, typically the vertical centerline, which has teeth 614 on either side and engages with a slot 607 the guide bearing 615 to fix motion of the support pieces 602 and 604 upward and downward. In other embodiments, the guide bearing 615 interacts with the top support piece 602. Also, in FIG. 6, the top support piece 602 includes two wing portions 608 on its lower end/side, with a gap in between the wing portions 608. Each wing portion 608 interacts with a lever 640 via, for example, contacting a roller 640, and may have teeth 612 on an inner wing surface. The gap between the wing portions 608 are sized to fit the gears 620 and the vertical element 606 of the bottom support piece 604, while also allowing movement of the bottom support piece 604 during use.

This configuration allows movement for full extension of the retention elements 631, 632 and 633 to allow for installation and removal of a personal entertainment device and account for different device sizes. When a personal entertainment device is installed and the lever 640 released, the springs 650 bias the retention elements 631, 632, and 633 against the edges of the personal entertainment device, and provide secure retention of the device. To remove the device, the lever(s) 640 are pushed to extend the support pieces 602 and 604 and therefore the retention elements 631, 632 and 633 (allowing removal of the device).

In some embodiments, one or more of the thermoplastic elements might be formed simply of thermoplastic (e.g. the same thermoplastic material as the composite material) without any reinforcing fibers, but in other embodiments the elements might be molded with thermoplastic resin (e.g. the same thermoplastic material as the composite material) while having reinforcing fibers dispersed throughout the resin to provide additional strength. It should be noted, however, that any such fibers in thermoplastic resin during injection molding would not have the same precision of orientation and location as the weave of reinforcing fibers located in the composite material.

In some embodiment, some or all of the composite material optionally used in the device mount assembly may be multi-layered (for example, formed of two or more layers of composite). This layering of composites may provide for additional structural support for the element. While some embodiments may require multi-layered composite support throughout the element, in other embodiments one or more layers of composite may be used for most of the element, with additional layer(s) used only in critical areas of the element requiring greater structural support. Typically, the multiple layers of composite may be securely affixed (for example, fused together, as by ultrasonic welding, thermal staking, thermal welding, consolidation, homogeneously affixed, or other such joining means). And in some embodiments, the multiple layers of composite may be oriented so that the reinforcing fibers of each layer are oriented differently. By altering the fiber orientation of the layers, the joint composite may provide additional strength in some embodiments.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiments) are also within the scope of the disclosure. Accordingly, the scope of protection is not limited by the description set out above, but is defined by the claims which follow, that scope including all equivalents of the subject matter of the claims. In the claims, any designation of a claim as depending from a range of claims (for example #-##) would indicate that the claim is a multiple dependent claim based of any claim in the range (e.g. dependent on claim # or claim ## or any claim therebetween). Each and every claim is incorporated as further disclosure into the specification and the claims are embodiment(s) of the present invention(s). Furthermore, any advantages and features described above may relate to specific embodiments, but shall not limit the application of such issued claims to processes and structures accomplishing any or all of the above advantages or having any or all of the above features.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Specifically and by way of example, although the headings might refer to a “Field,” the claims should not be limited by the language chosen under this heading to describe the so-called field. Further, a description of a technology in the “Background” is not to be construed as an admission that certain technology is prior art to any invention(s) in this disclosure. Neither is the “Summary” to be considered as a limiting characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of the claims shall be considered on their own merits in light of this disclosure, but should not be constrained by the headings set forth herein.

Use of broader terms such as comprises, includes, and having should be understood to provide support for narrower terms such as consisting of, consisting essentially of, and comprised substantially of. Use of the term “optionally,” “may,” “might,” “possibly,” and the like with respect to any element of an embodiment means that the element is not required, or alternatively, the element is required, both alternatives being within the scope of the embodiments). Also, references to examples are merely provided for illustrative purposes, and are not intended to be exclusive.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

Although various embodiments of the method and system of the present invention have been illustrated in the accompanying Drawings and described in the foregoing Specification, it will be understood that the invention is not limited to the embodiments disclosed, but is capable of numerous rearrangements, modifications, and substitutions without departing from the spirit and scope of the invention as set forth herein. It is intended that the Specification and examples be considered as illustrative only.

What is claimed is:

1. A mount assembly for a personal entertainment device, the mount assembly comprising:
a mount plate;
a rotatable bracket element coupled to the mount plate;
an enclosure coupled to the rotatable bracket element, the enclosure having a plurality of adjustable retention members slidably disposed therein; and
at least one retention member of the plurality of adjustable retention members being linearly adjustable to facilitate receipt of a personal device by the enclosure.

2. The mount assembly of claim 1, wherein the rotatable bracket comprises a plurality of articulatable linkages.

3. The mount assembly of claim 2, wherein the plurality of articulatable linkages facilitate positional adjustment of the enclosure.

4. The mount assembly of claim 1, wherein the mount plate comprises a mounting button that engages an aperture formed in a back of an aircraft seat.

5. The mount assembly of claim 4, wherein a spring-biased door covers the aperture when the mounting button is removed.

6. The mount assembly of claim 1, wherein the plurality of retention members comprise a first retention member located on a first side of the enclosure and a second retention member located on a second side of the enclosure, the first side being opposed to the second side.

7. The mount assembly of claim 6, wherein at least one of the first retention member and the second retention member comprises a geared element that engages with a dimension adjustment element to facilitate adjustment of the at least one of the first retention member and the second retention member.

8. The mount assembly of claim 7, wherein the dimension adjustment element is a rotatable knob.

9. The mount assembly of claim 7, wherein the dimension adjustment element is a lever.

10. The mount assembly of claim 6, wherein the first retention member and the second retention member each comprise a geared element that engages with a dimension adjustment element to facilitate simultaneous adjustment of the first retention member and the second retention member in opposed directions.

11. The mount assembly of claim 10, wherein the dimension adjustment element is a rotatable knob.

12. The mount assembly of claim 11, wherein the dimension adjustment element is a lever.

13. A method of mounting a personal entertainment device, the method comprising:
adjusting a retention member to facilitate receipt of the personal entertainment device into an enclosure;
placing the personal entertainment device in the enclosure;
adjusting the retention member such that the personal entertainment device is secured in the enclosure; and
adjusting, via a rotatable mounting bracket, a position of the enclosure to facilitate viewing.

14. The method of claim 13, wherein the adjusting the retention member comprises actuating a rotatable knob, the rotatable knob having a geared interface with the retention member.

15. The method of claim 14, wherein the actuating the rotatable knob moves a first retention member and a second retention member, the first retention member and the second retention member being disposed on opposite sides of the enclosure.

16. The method of claim 15, wherein the first retention member and the second retention member are simultaneously moved in opposite directions.

17. The method of claim 13, wherein the adjusting the retention member comprises actuating a lever.

18. The method of claim 13, wherein the adjusting the position of the enclosure comprises actuating a plurality of articulatable linkages relative to each other the plurality of articulatable linkages together comprising the rotatable bracket.

19. The method of claim 13, comprising mounting the rotatable mounting bracket to a back of an aircraft seat.

20. The method of claim 19, wherein the mounting comprises receiving a mounting button into an aperture formed in the back.
